(19) United States
(12) Patent Application Publication
(10) Pub. No.: US 2005/0019544 A1
(43) Pub. Date: Jan. 27, 2005

(54) Foam seat element

(76) Inventors: Roberta L. Stacey, Maple (CA); Michael J. Cicone, Orchard Lake, MI (US)

Correspondence Address: PATENT ADMINSTRATOR;KATTEN MUCHIN ZAVIS ROSENMAN, 525 WEST MONROE STREET, SUITE 1600, CHICAGO, IL, 60661-3693, US

(21) Appl. No.: 10/835,283

(22) Filed: Apr. 30, 2004

Related U.S. Application Data
(60) Provisional application No. 60/466,405, filed on Apr. 30, 2003.

(51) Int. Cl. B32B 3/06

(52) U.S. Cl. 428/304.4; 264/46.4

(57) ABSTRACT

There is described a foam seat element comprising an isocyanate-based foam matrix having an A-surface for contact with an occupant and a B-surface for contact with a support element. An elastomeric layer is disposed on at least a portion of the B-surface for contact with the support element. This approach results in reduction in labour to produce the elastomeric layer compared with correct positioning of cloth inserts on a foam production manufacturing line. Further, since, in the preferred embodiment of the invention, the elastomeric layer is achieved by spraying a liquid elastomer-forming composition on a portion of the mold surface, the costs of achieving the elastomeric layer are significantly less than those associated with using prefabricated, pre-cut cloth inserts. Still further, the use of an elastomeric layer allows for tuning of the thickness of that layer which facilitates “tuning” the durability of the B-surface of the foam seat element based on the specific suspension system with which it will be combined. By the use of currently available robotic spraying systems, the degree of thickness of the elastomeric layer can be controlled in an automated fashion—this further reduces the costs associated with adjusting the durability of the B-surface of the foam seat element (for example compared to producing and stocking cloth inserts of different composition and/or thickness to achieve confer different durability properties).

### CROSS-REFERENCE TO RELATED APPLICATION

The present application claims the benefit under 35 U.S.C. §119(e) of provisional patent application Ser. No. 60/466,450, filed Apr. 30, 2003, the contents of which are hereby incorporated by reference.

### BACKGROUND OF THE INVENTION

1. Field of the Invention

In one of its aspects, the present invention relates to a foam seat element, particularly one useful in production of a vehicular seat (or element thereof). In another of its aspects, the present invention relates to a process for production of such a foam seat element.

2. Description of the Prior Art

Isocyanate-based polymers are known in the art. Generally, those of skill in the art understand isocyanate-based polymers to be polyurethanes, polyureas, polyisocyanurates and mixtures thereof.

It is also known in the art to produce foamed isocyanate-based polymers. Indeed, one of the advantages of isocyanate-based polymers compared to other polymer systems is that polymerization and foaming can occur in situ. This results in the ability to mold the polymer while it is forming and expanding.

One of the conventional ways to produce a polyurethane foam is known as the “one-shot” technique. In this technique, the isocyanate, a suitable polyol, a catalyst, water (which acts as a reactive “blowing” agent and can optionally be supplemented with one or more physical blowing agents) and other additives are mixed together at once using, for example, impingement mixing (e.g., high pressure). Generally, if one were to produce a polyurea, the polyol would be replaced with a suitable polyamine. A polyisocyanurate may result from cyclotrimerization of the isocyanate component. Urethane modified polyureas or polyisocyanurates are known in the art. In either scenario, the reactants would be intimately mixed very quickly using a suitable mixing technique.

Another technique for producing foamed isocyanate-based polymers is known as the “prepolymer” technique. In this technique, a prepolymer is produced by reacting polyol and isocyanate (in the case of a polyurethane) in an inert atmosphere to form a liquid polymer terminated with reactive groups (e.g., isocyanates). To produce the foamed polymer, the prepolymer is thoroughly mixed with a lower molecular weight polyol (in the case of producing a polyurethane) or a polyamine (in the case of producing a modified polyurea) in the presence of a curing agent and other additives, as needed.

As is known in the art, foamed isocyanate-based polymers are commonly used to produce parts used in vehicles. These include seats and various trim components.

When a foamed isocyanate-based polymer is used in a vehicle seat (e.g., a passenger seat), it is known in the art that, while the resiliency of the foam material in the seat provides passenger comfort, it does not typically provide the necessary structural strength for the seat. This necessitates additional reinforcement of the seat to provide the degree of structural strength to ensure proper mounting of the seat within the vehicle and, optionally, proper support for anti-submarine features and the like.

A variety of so-called seat suspension systems have been used over the years. One of the commonly used systems is the so-called Flex-o-Lator™ suspension system which consists of a perimeter frame that supports the B-surface (this is the underside opposite the principal seating surface) of the foam element via a series of wires which are connected to the frame by a series of springs. This suspension system has found significant popularity in the North American automobile market. The springs used in a suspension system can be altered to alter the deflection properties of the suspension system.

When combining such a suspension system with a foam seat element, it is conventional to mold into the B-surface of this foam seat element a layer of cloth which is in substantial alignment with the wires and springs of the suspension system. The cloth serves at least two purposes, namely to protect damage to the foam seat element (or confer durability to the foam seat element) by the suspension system (this is the primary purpose) and, in some cases, to minimize so-called BSR (buzz/squeak/rattle) problems.While this approach has been successful, there is still room for improvement.

For example, the requirement to use such a cloth layer adds labour and material cost to the fabrication process for producing the foam seat element. There is always a need in the art to reduce labour and/or material costs in the fabrication of foam seat elements without concurrent loss of properties or functionality of the seat elements.

### SUMMARY OF THE INVENTION

It is an object of the present invention to obviate or mitigate at least one of the above-mentioned disadvantages of the prior art.

Accordingly, in one of its aspects, the present invention relates to a foam seat element comprising an isocyanate-based foam matrix having an A-surface for contact with an occupant and a B-surface for contact with a support element, at least a portion of the B-surface for contact with the support element comprising an elastomeric layer.

In another of its aspects, process for producing a foam seat element in a mold comprising a first mold half and a second mold, the first mold half comprising a first surface corresponding to a B-surface of the foam seat element, the first mold half and the second mold half being engageable to define a mold cavity, the process comprising the steps of:

(i) disposing an elastomeric layer on at least a portion of the first surface of the first mold half;

(ii) dispensing a liquid foamable composition in at least one of the first mold half and the second mold half;

(iii) closing the first mold half and the second mold half;

(iv) expanding the liquid foamable composition to substantially completely fill the mold cavity to produce the foam element.

Thus, the present inventors have discovered a different approach of enhancing the durability of the B-surface of a foam seat element. This novel approach involves the use of an elastomeric layer in place of conventional cloth inserts. This approach has many attendant advantages.

Non-limiting examples of such advantages include significant reduction in labour to reduce the elastomeric layer compared with correct positioning of cloth inserts on a foam production manufacturing line. Further, since, in the preferred embodiment of the invention, the elastomeric layer is achieved by spraying a liquid elastomer-forming composition on a portion of the mold surface, the costs of achieving the elastomeric layer are significantly less than those associated with using prefabricated, pre-cut cloth inserts. Still further, the use of an elastomeric layer allows for tuning of the thickness of that layer which facilitates “tuning” the durability of the B-surface of the foam seat element based on the specific suspension system with which it will be combined. By the use of currently available robotic spraying systems, the degree of thickness of the elastomeric layer can be controlled in an automated fashion—this further reduces the costs associated with adjusting the durability of the B-surface of the foam seat element (for example compared to producing and stocking cloth inserts of different composition and/or thickness to achieve confer different durability properties).

### DETAILED DESCRIPTION OF THE PREFERRED EMBODIMENTS

Throughout this specification, reference is made to an A-surface and a B-surface in relation to a foam seat element. As will be understood by those of skill in the art, the term “A-surface” refers to the surface of the foam seat element with which the occupant will be in contact. Further, as will be understood by those of skill in the art, the term “B-surface” refers to the surface of the foam seat element in contact with a support or suspension system (this can include the frame of the seat and/or the suspension elements secured to the frame) affixed to the vehicle—in most cases this is simply the underside of the foam seat element.

An aspect of the present invention relates to a foam element useful in a vehicular seat such as a passenger seat. As used throughout this specification, the term “seat” is intended to have its conventional meaning and includes one or both of a cushion (i.e., the portion of the seat on which the occupant sits) and a back or backrest (i.e., the portion of the seat which supports the back of the occupant). As is known in the automotive, airline and related industries, a “seat” includes both a cushion and a back (or a backrest). Thus, as used herein, the term “seat” includes a cushion, a back (or backrest) or a unit construction comprising a cushion and a back (or backrest).

Preferably, the A-surface and the B-surface of the present foam seat element are substantially opposed to one another.

Preferably the present foam seat element comprises an isocyanate-based foam matrix, more preferably a polyurethane foam matrix.

Preferably, the elastomeric layer comprises a thickness of less than or equal to about 3.0 mm. More preferably, the elastomeric layer comprises a thickness of less than or equal to about 2.5 mm. Even more preferably, the elastomeric layer comprises a thickness of less than or equal to about 1.5 mm. Even more preferably, the elastomeric layer comprises a thickness in the range of from about 0.01 mm to about 1.5 mm. Most preferably, the elastomeric layer comprises a thickness in the range of from about 0.01 mm to about 1.0 mm.

Preferably, the elastomeric layer is substantially non-cellular. More, preferably, comprises an elastomer coating. Such an elastomeric coating can be produced in situ in a mold used to produce the foam matrix. See, for example, International Publication Number WO 02/11968 [Smith et al.] for the teaching of in situ production of an elastomeric coating on a surface of a foam matrix during production of the latter in a mold.

Preferably, the elastomeric layer is derived from an emulsion composition comprising polymer particles.

The particular composition used to produce the elastomeric layer conveniently may be in liquid, sprayable form. In many applications the elastomer layer produced from such a composition will be a substantially fluid impermeable coating—i.e., a coating which is substantially impermeable to gases and/or liquids. A particularly preferred coating composition is an acrylonitrile-based emulsion coating composition. Such a composition is commercially available from Akzo Nobel Coatings Inc. as a black barrier emulsion composition which is available a liquid. The liquid emulsion may be sprayed and the solvent therein will evaporate relatively quickly leaving the elastomer layer on the mold surface. Thus, this preferred coating may be regarded as a one part system.

Of course, other coatings are possible including the so-called “two-part” systems where two streams are mixed at the head of the spray gun and react with one another substantially instantaneously to produce the coating.

Other coating approaches which will work in the present process include in-mold paints or coatings based on polyurethane, and/or polyurea.

In a preferred embodiment, the present foam seat element further comprises a frame element which is at least partially embedded in the foam matrix.

Preferably, the present foam seat element is utilized in a vehicular seat such as one or both of a vehicular seat cushion and a vehicular seat backrest.

Preferably, the vehicular seat comprises the foam seat element and a support element in contacting relationship with the B-surface of the foam seat element. Preferably, the support element comprises a suspension element in contacting relationship with the B-surface of the foam seat element. Preferably, the suspension element comprises a least one biasing element. More preferably, the suspension element comprises a plurality of biasing elements. A preferred biasing element is a spring, optionally in combination with one or more wires

Thus, the support system coupled with the foam seat element is preferably is a seat suspension system.

The seat suspension system may be the Flex-o-Lator™ system discussed above.

A seat suspension system which also may be used is known in the art as a Sinuous Spring suspension system. This system is similar to the Flex-o-Lator™ system except, instead of straight wires supporting the foam element/trim cover combination, sine or square wave shaped steel springs are attached to support this combination. This system has been popular in the Japanese market. Deflection of this system is varied by controlling one or more of spring gauge, frequency of the wave, shape, amplitude of the wave shape and configuration of the wave shape.

It is also possible to utilize a non-metal support systems in seat pans for vehicular applications. Thus, it is known to utilize a Dymetrol™ material in place of the wires and sine waves of the systems described above. The Dymetrol™ material consists of a woven fabric having an elastomeric filament disposed therein. The advantages of this system are that it is lightweight, provides higher damping properties, is durable and has potential for supporting thin seating.

A similar system to the Dymetrol™ material is referred to in the art as the Pirelli Mat. This material is popular in Europe and has the potential for improving support for thin seating. Further, the material is recyclable. See also the teachings of British patent 1,500,725 for a discussion of the Pirelli Mat.

Alternatively, the suspension system may the one described in International Publication Number WO 03/031223 [Weierstall].

The present process for producing the foam seat element involves a mold comprising a first mold half and a second mold. In many cases, the first mold half may be considered as the lid and the second mold half may be considered as the bowl. The first mold half comprises a first surface corresponding to a B-surface of the foam seat element. The first mold half and the second mold half are engageable to define a mold cavity.

The process comprising the steps of: (i) disposing an elastomeric layer on at least a portion of the first surface of the first mold half; (ii) dispensing a liquid foamable composition in at least one of the first mold half and the second mold half; (iii) closing the first mold half and the second mold half; (iv) expanding the liquid foamable composition to substantially completely fill the mold cavity to produce the foam element.

Preferably, Step (i) comprises spraying a liquid elastomer-forming composition of the type described above on the first surface of the first mold half.

Preferably, Step (ii) comprises dispensing the liquid foamable composition in the second mold half.

Preferably, the liquid foamable composition comprises an isocyanate-based foam forming reaction mixture. More preferably, the liquid foamable composition comprises a polyurethane foam forming reaction mixture.

Preferably, the process comprises the further step of applying a mold release agent to one or both of the first mold half and the second mold half. More preferably, the mold release agent is applied prior to Step (i).

Preferably, prior to Step (iii), a frame element is disposed in at least one of the first mold half and the second mold half.

While this invention has been described with reference to illustrative embodiments and examples, the description is not intended to be construed in a limiting sense. For example it is possible substitute the elastomeric layer described above with a non-elastomeric layer (e.g., polymeric, non-polymeric, fibrous, etc.). Thus, various modifications of the illustrative embodiments, as well as other embodiments of the invention, will be apparent to persons skilled in the art upon reference to this description. It is therefore contemplated that the appended claims will cover any such modifications or embodiments.

All publications, patents and patent applications referred to herein are incorporated by reference in their entirety to the same extent as if each individual publication, patent or patent application was specifically and individually indicated to be incorporated by reference in its entirety.

1. A foam seat element comprising an isocyanate-based foam matrix having an A-surface for contact with an occupant and a B-surface for contact with a support element, at least a portion of the B-surface for contact with the support element comprising an elastomeric layer.

2. The foam seat element defined in claim 1, wherein the A-surface and the B-surface are substantially opposed to one another.

3. The foam seat element defined in claim 1, wherein the foam matrix comprises an isocyanate-based foam matrix.

4. The foam seat element defined in claim 1, wherein the elastomeric layer comprises a thickness of less than or equal to about 3.0 mm.

5. The foam seat element defined in claim 1, wherein the elastomeric layer comprises a thickness of less than or equal to about 2.5 mm.

6. The foam seat element defined in claim 1, wherein the elastomeric layer comprises a thickness of less than or equal to about 1.5 mm.

7. The foam seat element defined in claim 1, wherein the elastomeric layer comprises a thickness in the range of from about 0.01 mm to about 1.5 mm.

8. The foam seat element defined in claim 1, wherein the elastomeric layer comprises a thickness in the range of from about 0.01 mm to about 1.0 mm.

9. The foam seat element defined in claim 1, wherein the elastomeric layer is substantially non-cellular.

10. The foam seat element defined in claim 1, wherein the elastomeric layer comprises an elastomer coating.

11. The foam seat element defined in claim 1, wherein the elastomeric layer is produced in situ in a mold used to produce the foam matrix.

12. The foam seat element defined in claim 1, wherein the elastomeric layer is derived from an emulsion composition comprising polymer particles.

13. The foam seat element defined in claim 1, further comprising a frame element which is at least partially embedded in the foam matrix.

14. A vehicular seat comprising the foam seat element defined in claim 1.

15. A vehicular seat cushion comprising the foam seat element defined in claim 1.

16. A vehicular seat backrest comprising the foam element defined in claim 1.

17. A vehicular seat comprising the foam seat element defined in any one of claims 1 and a support element in contacting relationship with the B-surface of the foam seat element.

18. The vehicular seat defined in claim 17, wherein the support element comprises a suspension element in contacting relationship with the B-surface of the foam seat element.

19. The vehicular seat defined in claim 18, wherein the suspension element comprises a least one biasing element.

20. The vehicular seat defined in claim 18, wherein the suspension element comprises a plurality of biasing elements.

21. The vehicular seat defined in claim 18, wherein the biasing element comprises a spring.

22. A process for producing a foam seat element in a mold comprising a first mold half and a second mold, the first mold half comprising a first surface corresponding to a B-surface of the foam seat element, the first mold half and the second mold half being engageable to define a mold cavity, the process comprising the steps of:
(i) disposing an elastomeric layer on at least a portion of the first surface of the first mold half;
(ii) dispensing a liquid foamable composition in at least one of the first mold half and the second mold half;
(iii) closing the first mold half and the second mold half;
(iv) expanding the liquid foamable composition to substantially completely fill the mold cavity to produce the foam element.

23. The process defined in claim 22, wherein the elastomeric layer is substantially non-cellular.

24. The process defined in claim 22, wherein Step (i) comprises applying the elastomeric material at a thickness of less than or equal to about 3.0 mm.

25. The process defined in claim 22, wherein Step (i) comprises applying the elastomeric material at a thickness of less than or equal to about 2.5 mm.

26. The process defined in claim 22, wherein Step (i) comprises applying the elastomeric material at a thickness of less than or equal to about 1.5 mm.

27. The process defined in claim 22, wherein Step (i) comprises applying the elastomeric material at a thickness in the range of from about 0.1 mm to about 1.5 mm.

28. The process defined in claim 22, wherein Step (i) comprises applying the elastomeric material at a thickness in the range of from about 0.1 mm to about 1.0 mm.

29. The process defined in claim 22, wherein Step (i) comprises spraying a liquid elastomer-forming composition on the first surface of the first mold half.

30. The process defined in claim 29, wherein the liquid elastomer-forming composition comprises an emulsion composition comprising particles dispersed in a liquid material.

31. The process defined in claim 22, wherein Step (ii) comprises dispensing the liquid foamable composition in the second mold half.

32. The process defined in claim 22, wherein the liquid foamable composition comprises an isocyanate-based foam forming reaction mixture.

33. The process defined in claim 22, wherein the liquid foamable composition comprises a polyurethane foam forming reaction mixture.

34. The process defined in claim 22, comprising the further step of applying a mold release agent to one or both of the first mold half and the second mold half.

35. The process defined in claim 34, wherein the mold release agent is applied prior to Step (i).

36. The process defined in claim 22, wherein, prior to Step (iii), a frame element is disposed in at least one of the first mold half and the second mold half.
